(19) United States
(12) Patent Application Publication
(10) Pub. No.: US 2015/0154904 A1
(43) Pub. Date: Jun. 4, 2015

(54) LIGHT EMITTING DEVICE CONTROL CIRCUIT AND CONTROL METHOD THEREOF

(71) Applicants: Chien-Hua Lin, Xiushui Township (TW); Shui-Mu Lin, Taichung (TW); Ti-Ti Liu, Taipei (TW); Ching-Yu Chen, Guanxi Township (TW); Yung-Chun Chuang, Taipei (TW); Chin-Hui Wang, New Taipei (TW); Shei-Chie Yang, Taichung (TW)

(72) Inventors: Chien-Hua Lin, Xiushui Township (TW); Shui-Mu Lin, Taichung (TW); Ti-Ti Liu, Taipei (TW); Ching-Yu Chen, Guanxi Township (TW); Yung-Chun Chuang, Taipei (TW); Chin-Hui Wang, New Taipei (TW); Shei-Chie Yang, Taichung (TW)

(73) Assignee: RICHTEK TECHNOLOGY CORPORATION, R.O.C, Zhubei City (TW)

(21) Appl. No.: 14/555,631

(22) Filed: Nov. 27, 2014

Related U.S. Application Data
(60) Provisional application No. 61/910,715, filed on Dec. 2, 2013.

(51) Int. Cl. G09G 3/32; H05B 37/02

(52) U.S. Cl. CPC G09G 3/32; H05B 37/0281; G09G 2320/064

(57) ABSTRACT

The present invention discloses a light emitting device control circuit and a control method thereof, for controlling a light emitting device array display. The present invention controls not only the conduction timing and duration of one or more selected light emitting devices in the light emitting device array display, but also controls the current flowing through the selected light emitting devices by a variable current source, such that in one frame of a given length, the resolution of the brightness of the light emitting devices is increased.

### CROSS REFERENCE

The present application claims priority to U.S. 61/910715, filed on Dec. 2, 2013.

### BACKGROUND OF THE INVENTION

1. Field of Invention

The present invention relates to a light emitting device control circuit and a control method thereof; particularly, it relates to such a light emitting device control circuit and a control method which can increase the refresh rate.

2. Description of Related Art

FIG. 1A shows a conventional light emitting diode (LED) control circuit 110 for controlling the image and brightness of an LED array display 10. As shown in FIG. 1A, a power supply circuit 120 supplies power to the LED array display 10, and the LED control circuit 110 decides which ones of the LEDs (not shown) in the LED array display 10 should be turned ON, and the brightness of the turned-ON LEDs. To simplify the drawing, FIG. 1A only shows that the LED control circuit 110 controls one group of LEDs of the LED array display 10. In practical application, the LED array display 10 includes plural LEDs arranged in an array of rows and columns controlled by the LED control circuit 110, and the LEDs display an image according to a scanning sequence, that is, first, selected one or more LEDs in a first row are turned ON, and next, selected one or more LEDs in a second row are turned ON, and further next, selected one or more LEDs in a third row are turned ON, etc. The LED control circuit 110 includes plural timing switches 111, plural current source circuits CS1 and a timing control circuit 113. The timing control circuit 113 generates a control signal which controls the timing switches 111 to determine the turned-ON timing and duration (i.e., conduction period) of the selected one or more LEDs. When a timing switch 111 is turned ON, the corresponding current source circuit CS1 provides a constant current I1, which is the LED current IL1, to the selected one or more LEDs.

The control signal for example can be determined by an N-bit digital signal (wherein N is a positive integer). As shown in FIG. 1B, one frame TF1 can be divided into 2^{N} units, each unit has a unit time T, and the control signal determines the conduction period of the timing switch 111 according to the N-bit digital signal so as to correspondingly control the brightness of the selected one or more LEDs. The brightness of the selected one or more LEDs will be higher if the conduction period is longer. Under the circumstance that the unit time T is fixed, if the number N is larger, the controllable brightness variation will be larger, that is, the gray scale resolution is higher; however, the total time of one frame TF1 will be longer, which means that the refresh rate is lower.

In the prior art, usually the unit time T has approached the hardware limit and can not be shortened anymore. Therefore, if one intends to increase the refresh rate, then the number N has to be lowered, which reduces the controllable brightness variation. That is, to increase the refresh rate will sacrifice the resolution, while to increase the resolution will sacrifice the refresh rate.

In view of the above, to solve the dilemma in the prior art, the present invention provides a light emitting device control circuit and a control method which can increase the refresh rate without sacrificing the resolution, or increase the resolution without sacrificing the refresh rate.

### SUMMARY OF THE INVENTION

In one perspective, the present invention provides a light emitting device control circuit for controlling a light emitting device array display which includes a plurality of light emitting devices, the light emitting device control circuit comprising: a timing switch coupled to the light emitting device array display, wherein the timing switch is controlled by a timing control signal to determine a turned-ON timing and a conduction period of selected one or more light emitting devices in the light emitting device array display; a variable current source circuit coupled to the timing switch, wherein the variable current source circuit is controlled by a current control signal to determine a light emitting device current flowing through the selected one or more light emitting devices; and a timing and brightness control circuit coupled to the timing switch and the variable current source circuit, for generating the timing control signal and the current control signal; wherein the current control signal controls the variable current source circuit such that in at least a portion of the conduction period the light emitting device current is adjusted to be different from the light emitting device current in the rest portion of the conduction period.

In another perspective, the present invention provides a light emitting device control method for controlling a light emitting device array display which includes a plurality of light emitting devices, the light emitting device control circuit comprising: controlling a timing switch by a timing control signal to determine a turned-ON timing and a conduction period of selected one or more light emitting devices in the light emitting device array display; determining a light emitting device current flowing through the selected one or more light emitting devices by a current control signal; and in at least a portion of the conduction period, adjusting the light emitting device current to be different from the light emitting device current in the rest portion of the conduction period.

In one preferred embodiment, the light emitting device current has a predefined normal value, and when the light emitting device current is adjusted, the light emitting device current is adjusted to be smaller than the predefined normal value.

In one preferred embodiment, a brightness of the light emitting device array display has a gray scale resolution of 2^{N}, and the light emitting device array display is refreshed every frame, wherein one frame is divided to 2^{(N-M)} units of unit time, and the light emitting device current is adjustable to 2^{M} different current amounts, wherein N and M are both positive integers and N>M.

In one preferred embodiment, one frame is divided to 2^{Q} sub-frames, and each sub-frame is divided to 2^{(N-M-Q)} units of unit time; and wherein the conduction period is divided into a plurality of sub-conduction periods evenly distributed in the corresponding sub-frames, wherein a difference between two different sub-conduction periods is at most one unit of unit time.

In one preferred embodiment, one frame is divided to 2^{Q} sub-frames, and each sub-frame is divided to 2^{(N-M-Q)} units of unit time; and wherein the conduction period is divided into a plurality of sub-conduction periods distributed in the corresponding sub-frames, wherein a difference between at least one sub-conduction period and at least another sub-conduction period is two units or more of unit time.

The objectives, technical details, features, and effects of the present invention will be better understood with regard to the detailed description of the embodiments below, with reference to the attached drawings.

### BRIEF DESCRIPTION OF THE DRAWINGS

FIG. 1A shows a schematic circuit diagram of a conventional LED control circuit 110.

FIG. 1B shows the control signal in the conventional LED control circuit 110.

FIGS. 2A-2G shows a first embodiment of the present invention.

FIGS. 3A-3B show two embodiments of the variable current source.

FIG. 4 shows a second embodiment of the present invention.

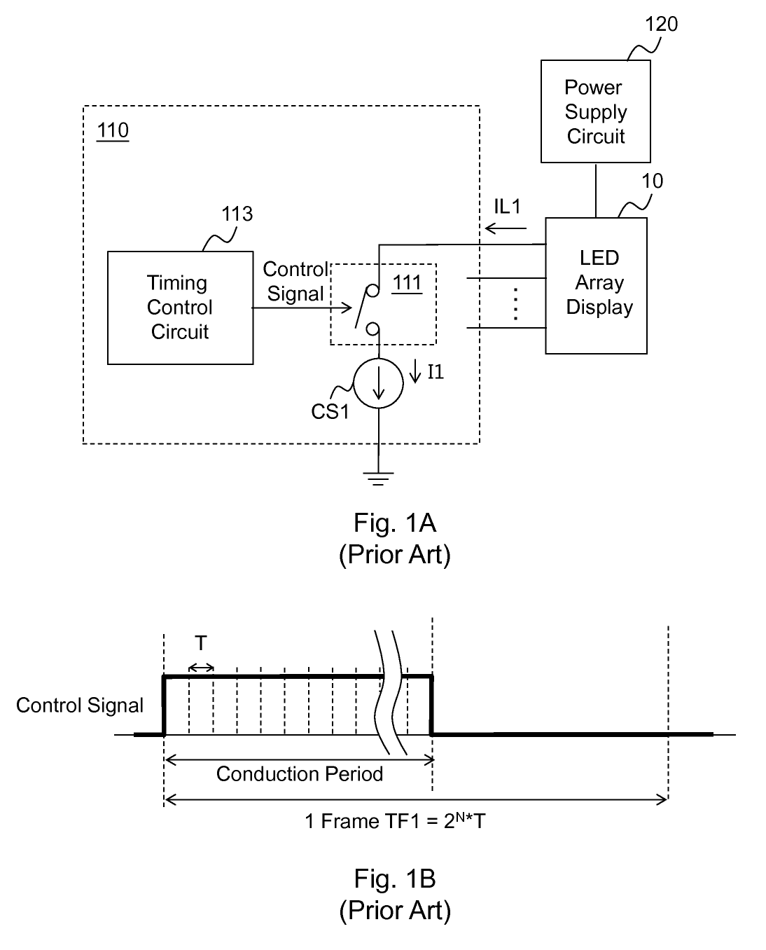

### DESCRIPTION OF THE PREFERRED EMBODIMENTS

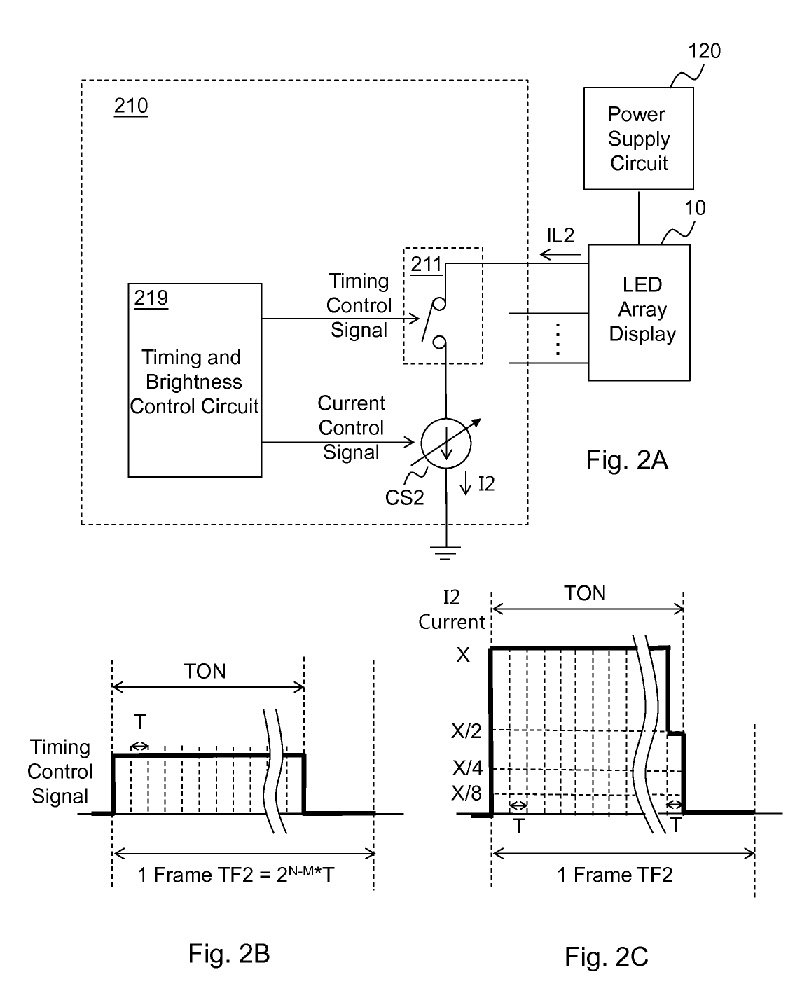

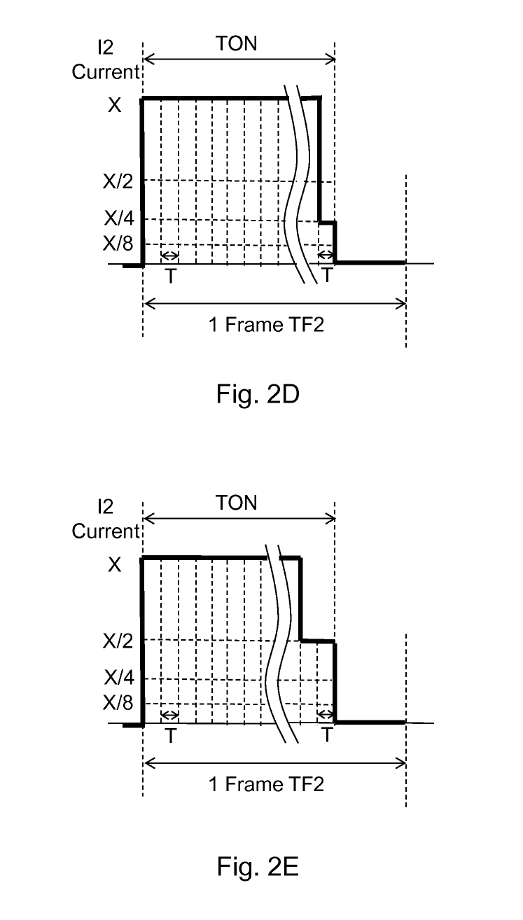

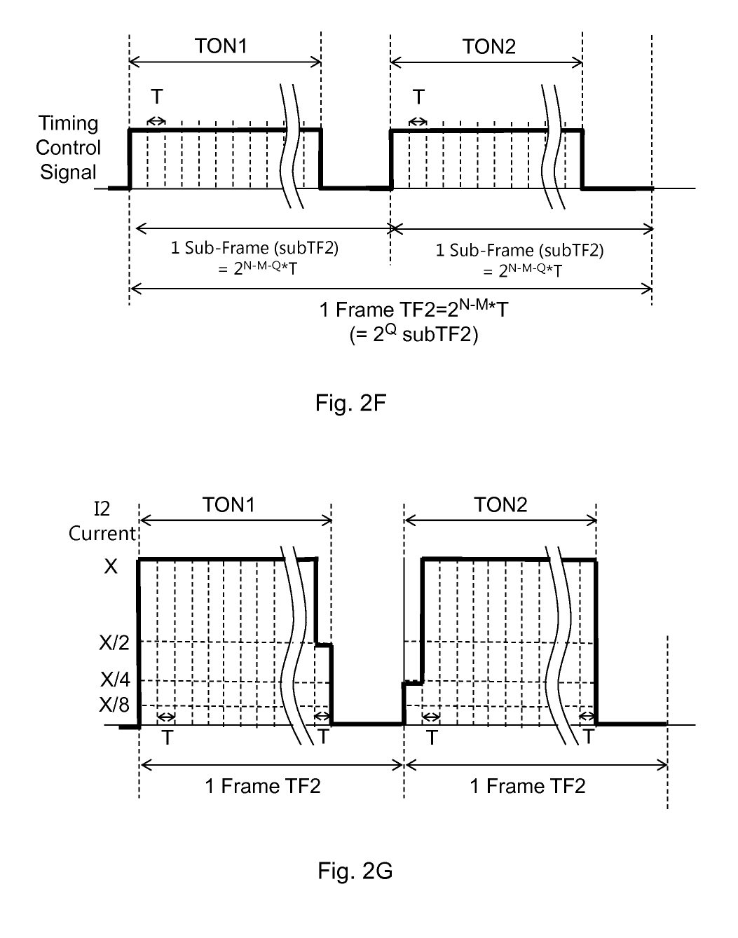

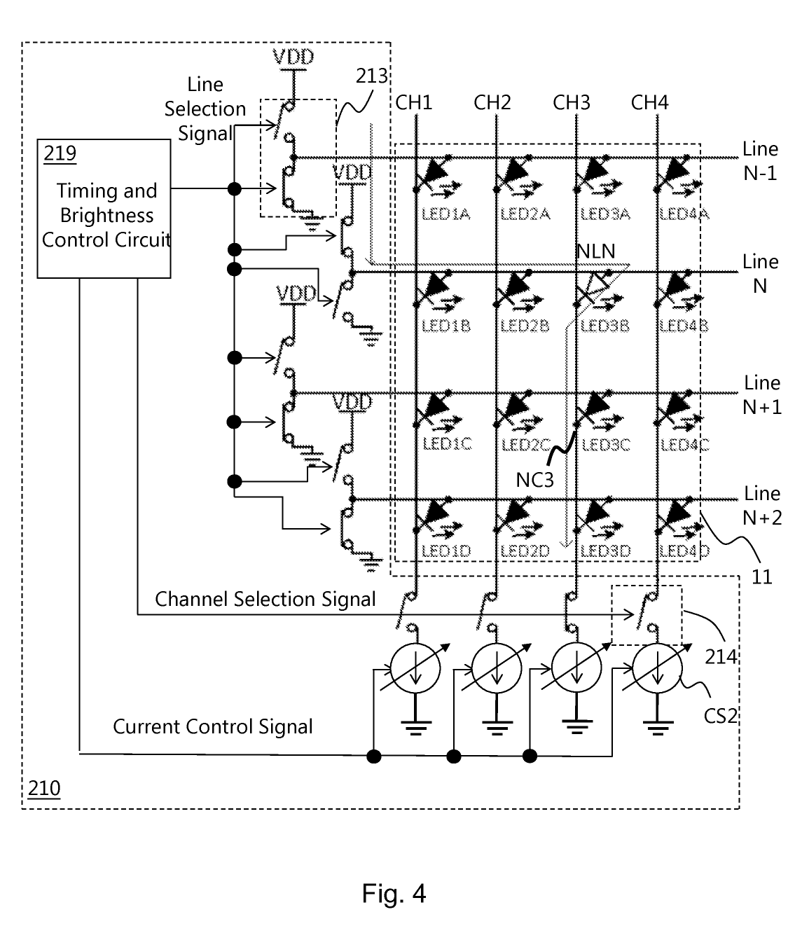

Please refer to FIGS. 2A-2G, which shows a light emitting device control circuit 210 according to a first embodiment of the present invention. The light emitting device control circuit 210 is for controlling the image and brightness of a light emitting device array display, such as an LED array display 10. As shown in FIG. 2A, a power supply circuit 120 supplies power to the LED array display 10, and the LED control circuit 110 decides which ones of the LEDs (referring to FIG. 4) in the LED array display 10 should be turned ON, and the brightness of the turned-ON LEDs. To simplify the drawing, FIG. 2A only shows that the light emitting device control circuit 210 controls one group of LEDs of the LED array display 10. In practical application, the LED array display 10 includes plural LEDs arranged in an array of rows and channels controlled by the light emitting device control circuit 210, and the LEDs display an image according to a scanning sequence. The light emitting device control circuit 210 includes plural timing switches 211, plural variable current source circuits CS2 and a timing and brightness control circuit 219. The timing and brightness control circuit 219 generates a timing control signal which controls the timing switches 211 to determine the turned-ON timing and duration (i.e., conduction period) of the selected one or more LEDs . When a timing switch 211 is turned ON, the corresponding variable current source circuit CS2 is enabled to provide a variable current I2, which is the LED current IL2, to the selected one or more LEDs . In addition, the timing and brightness control circuit 219 further generates a current control signal which controls the variable current I2 provided by the enabled variable current source circuit CS2, to determine the LED current IL2.

Referring to FIG. 2B, one frame TF2 is divided into 2^{N-M} units, each unit has a unit time T (wherein N and M are both positive integers and N>M). The timing control signal controls a selected timing switch 211 so that it is turned ON for a conduction period TON in one frame TF2, whereby selected one or more LEDs in the LED array display 10 are turned ON for a corresponding time period. In addition, referring to FIG. 2C, in the conduction period TON, the current control signal controls the variable current I2 provided by the enabled variable current source circuit CS2, to determine the LED current IL2, to thereby increase the resolution. For example, in one embodiment as shown in FIG. 2C, the current control signal controls the variable current I2 provided by the enabled variable current source circuit CS2, so that in one unit time T (for example but not limited to the last unit time T in the conduction period TON), the variable current I2 is adjusted to P/2^{M} of a predefined normal current (wherein P is a positive integer which is smaller or equal to 2^{M}). For example, assuming that the predefined normal current is X, and M=3, then in one unit time T of the conduction period TON, the variable current I2 can be adjusted to X/8, 2X/8, . . . , 8X/8. Thus, in comparison with the prior art, the total time of one frame is shortened from 2^{N}*T to 2^{N-M}*T in this embodiment, while the gray scale resolution is still 2^{N} by adjusting the variable current I2. In other words, the total time of one frame is shortened (the refresh rate is increased), while the resolution is not degraded. From another viewpoint, if the refresh rate is the same, then the resolution (the brightness variation of the LEDs) can be increased. Certainly, if the current resolution of the variable current source circuit CS2 is even higher (larger than 2^{M}), then the present invention can increase both the refresh rate and the resolution.

Please refer to FIGS. 2D and 2E. In the present invention, the adjustment of the variable current I2 is not limited to being performed in one single unit time T; the adjustment can be performed in two or more unit times T. For example, if the variable current I2 is adjusted to X/2 in two unit times T, it is equivalent to adjusting the variable current I2 to X/4 in one unit time T. To adjust the variable current I2 in two or more unit times can reduce the complexity of the variable current source circuit CS2 (the required current resolution of the variable current source circuit CS2 becomes lower), or, if the complexity of the variable current source circuit CS2 maintains the same, the refresh rate or the resolution, or both, of the LED array display 10 can be further increased.

It should be noted that the conduction period TON is not limited to starting from the beginning of one frame, as shown in FIGS. 2A-2E. It can reside in the middle or later part of one frame. Furthermore, the conduction period TON can be divided into plural sub-conduction periods. Please refer to FIGS. 2F and 2G. One frame is divided into plural sub-frames; in this embodiment, one frame TF2 having a time period of 2^{N-M}*T is divided into 2^{Q} sub-frames subTF2, wherein each sub-frame subTF2 has a time period of 2^{N-M-Q}*T (wherein Q is a positive integer and Q<(N-M)). The conduction period TON is divided into sub-conduction periods TON1 and TON2. In a preferred embodiment, the conduction period TON is evenly divided into sub-conduction periods (the term. “evenly” means that the difference between any two sub-conduction periods is 0T or 1T, since the conduction period TON is not necessarily divisible by Q). However, this is only preferred but not necessary. The sub-conduction periods TON1 and TON2 do not need to be substantially equal to each other (“not substantially equal” means that the difference between any two sub-conduction periods is 1T or more than 1T). In addition, the variable current I2 needs not be adjusted by the same way in the sub-conduction periods TON1 and TON2. To show an example, referring to FIG. 2G, the variable current I2 is adjusted at different timings and adjusted to different current amounts in the sub-conduction periods TON1 and TON2. Furthermore, the timing switch 211 (and thus the variable current source circuit CS2) does not necessarily need to be conductive in a complete period of each unit time T in the conduction period TON; for example, in each unit time T in the conduction period TON, the timing switch 211 (and thus the variable current source circuit CS2) can be turned ON in a pulse-width modulated form.

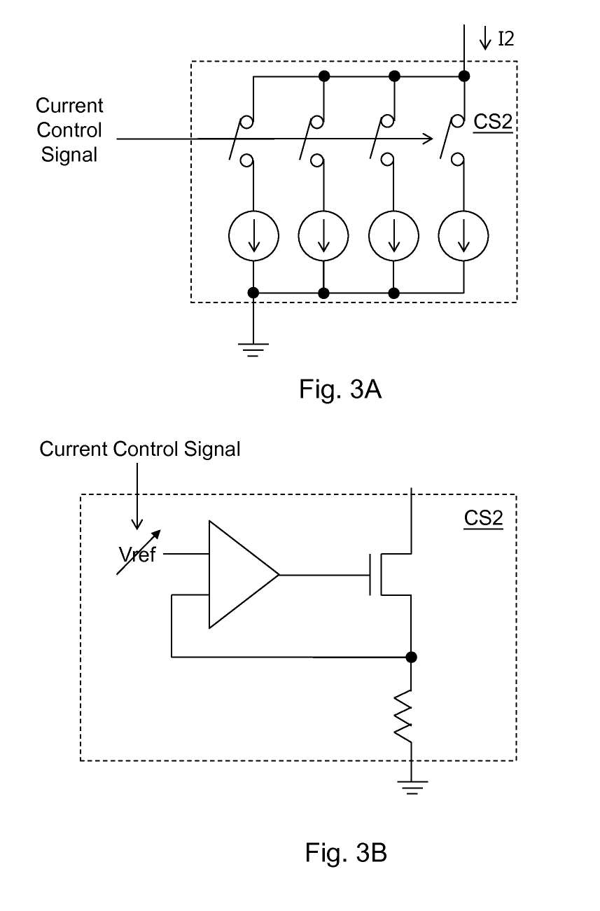

FIGS. 3A and 3B show two embodiments of the variable current source circuit CS2. In the embodiment of FIG. 3A, the current control signal for example can be a digital signal, controlling the variable current source circuit CS2 in a digital manner. The variable current source circuit CS2 includes plural fixed current source circuits, and the digital signal determines which one or ones of the fixed current source circuits are turned ON to control the total current, which is the current I2. In the embodiment of FIG. 3C, the current control signal for example can be an analog signal, controlling (or the analog signal itself is) a reference voltage Vref of the variable current source circuit CS2. When the reference voltage Vref changes, the current I2 correspondingly changes.

FIG. 4 shows a second embodiment of the present invention, which is an embodiment showing that the light emitting device control circuit 210 is applied to an LED array billboard. As shown in the figure, the LED array billboard includes an LED array 11 and the light emitting device control circuit 210, and the light emitting device control circuit 210 includes plural line switch circuits 213, plural channel switch circuits 214, a timing and brightness control circuit 219, and plural variable current source circuits CS2. The timing switches 211 in the first embodiment correspond to the channel switch circuits 214, or correspond to the combination of the line switch circuits 213 and the channel switch circuits 214 in this embodiment. The timing control signal in the first embodiment corresponds to the channel selection signal, or the combination of the line selection signal and the channel selection signal in this embodiment.

The LED array 11 includes plural LEDs, such as the LEDs LED1A˜LED4D, arranged by plural channels CH1˜CH4 and plural lines Line N−1˜Line N+2. In each line, the anodes of the LEDs are coupled to a common line node, such as the node NLN of the line N; in each channel, the cathodes of the LEDs are coupled to a common channel node, such as the node NC3 of the channel CH3. The line switch circuits 213 are coupled to the corresponding line nodes, and the line switch circuits 213 operate according to the line selection signals to selectively electrically connect the corresponding line nodes to a conduction voltage VDD or a discharge path (the discharge path is for example but not limited to the path from the line node through the lower switch in the line switch circuits 213 to the ground or a predetermined low potential). The conduction voltage VDD is for example 5V or a typical positive power supply voltage in an integrated circuit. The channel switch circuits 214 are coupled to the corresponding channel nodes, and the channel switch circuits 214 operate according to the channel selection signals to selectively electrically connect the corresponding channel nodes to the corresponding variable current source circuits CS2. The timing and brightness control circuit 219 generates the line selection signals and the channel selection signals to select one or more LEDs (such as the LED LED3B in the figure), so that the selected one or more LEDs are turned ON for a conduction period TON in one frame. In addition, during at least a portion of the conduction period TON, the timing and brightness control circuit 219 generates the current control signal to adjust the current amount of the variable current source circuits CS2, so as to adjust the current flowing through the selected one or more LEDs (such as the LED LED3B). This embodiment shows more specific details as to how the present invention can be applied to an LED billboard.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices shown to be in direction connection in the shown embodiments, such as a switch. For another example, the present invention can be applied to any direct current light emitting device, not limited to the LEDs. For another example, the meanings of the high and low levels of a digital signal are interchangeable, with corresponding amendments of the circuits processing these signals. For another example, it is not necessary for each of the lines and channels of the light emitting device array to have the same number of light emitting devices; there can be one or more lines or channels having different numbers of light emitting devices, and there also can be certain light emitting devices not arranged in lines and channels. For another example, a lighting unit shown to be composed of one LED in the embodiments (such as the LED LED1A) can be modified so that one light unit includes more than one LEDs (for example, the LED LED1A is replaced by two LEDs). For yet another example, the variable current I2 can be adjusted at any timing during the conduction period TON, not limited to the beginning or end of the conduction period TON. In view of the foregoing, the spirit of the present invention should cover all such and other modifications and variations, which should be interpreted to fall within the scope of the following claims and their equivalents.

What is claimed is:

1. A light emitting device control circuit for controlling a light emitting device array display which includes a plurality of light emitting devices, the light emitting device control circuit comprising:
a timing switch coupled to the light emitting device array display, wherein the timing switch is controlled by a timing control signal to determine a turned-ON timing and a conduction period of selected one or more light emitting devices in the light emitting device array display;
a variable current source circuit coupled to the timing switch, wherein the variable current source circuit is controlled by a current control signal to determine a light emitting device current flowing through the selected one or more light emitting devices; and
a timing and brightness control circuit coupled to the timing switch and the variable current source circuit, for generating the timing control signal and the current control signal;
wherein the current control signal controls the variable current source circuit such that in at least a portion of the conduction period the light emitting device current is adjusted to be different from the light emitting device current in the rest portion of the conduction period.

2. The light emitting device control circuit of claim 1, wherein the light emitting device current has a predefined normal value, and when the light emitting device current is adjusted, the light emitting device current is adjusted to be smaller than the predefined normal value.

3. The light emitting device control circuit of claim 1, wherein a brightness of the light emitting device array display has a gray scale resolution of 2^{N}, and the light emitting device array display is refreshed every frame, wherein one frame is divided to 2^{(N-M)} units of unit time, and the light emitting device current is adjustable to 2^{M} different current amounts, wherein N and M are both positive integers and N>M.

4. The light emitting device control circuit of claim 3, wherein one frame is divided to 2^{Q} sub-frames, and each sub-frame is divided to 2^{(N-M-Q)} units of unit time; and wherein the conduction period is divided into a plurality of sub-conduction periods evenly distributed in the corresponding sub-frames, wherein a difference between two different sub-conduction periods is at most one unit of unit time.

5. The light emitting device control circuit of claim 3, wherein one frame is divided to 2^{Q} sub-frames, and each sub-frame is divided to 2^{(N-M-Q)} units of unit time; and wherein the conduction period is divided into a plurality of sub-conduction periods distributed in the corresponding sub-frames, wherein a difference between at least one sub-conduction period and at least another sub-conduction period is two units or more of unit time.

6. A light emitting device control method for controlling a light emitting device array display which includes a plurality of light emitting devices, the light emitting device control circuit comprising:
controlling a timing switch by a timing control signal to determine a turned-ON timing and a conduction period of selected one or more light emitting devices in the light emitting device array display;
determining a light emitting device current flowing through the selected one or more light emitting devices by a current control signal; and
in at least a portion of the conduction period, adjusting the light emitting device current to be different from the light emitting device current in the rest portion of the conduction period.

7. The light emitting device control method of claim 6, wherein the light emitting device current has a predefined normal value, and when the light emitting device current is adjusted, the light emitting device current is adjusted to be smaller than the predefined normal value.

8. The light emitting device control method of claim 6, wherein a brightness of the light emitting device array display has a gray scale resolution of 2^{N}, and the light emitting device array display is refreshed every frame, wherein one frame is divided to 2^{(N-M)} units of unit time, and the light emitting device current is adjustable to 2^{M} different current amounts, wherein N and M are both positive integers and N>M.

9. The light emitting device control method of claim 8, wherein one frame is divided to 2^{Q} sub-frames, and each sub-frame is divided to 2^{(N-M-Q)} units of unit time; and wherein the conduction period is divided into a plurality of sub-conduction periods evenly distributed in the corresponding sub-frames, wherein a difference between two different sub-conduction periods is at most one unit of unit time.

10. The light emitting device control method of claim 8, wherein one frame is divided to 2^{Q} sub-frames, and each sub-frame is divided to 2^{(N-M-Q)} units of unit time; and wherein the conduction period is divided into a plurality of sub-conduction periods distributed in the corresponding sub-frames, wherein a difference between at least one sub-conduction period and at least another sub-conduction period is two units or more of unit time.
